(19) United States
(12) Patent Application Publication
(10) Pub. No.: US 2010/0175956 A1
(43) Pub. Date: Jul. 15, 2010

(54) VISCOUS PENDULUM DAMPER

(75) Inventor: Rick Ian Zadoks, Dunlap, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/352,912

(22) Filed: Jan. 13, 2009

(51) Int. Cl. F16F 9/06; F16F 9/30

(52) U.S. Cl. 188/268; 188/269

(57) ABSTRACT

A damper that shears a fluid to dampen rotational force fluctuations and moves a plurality of masses within a fluid to dampen dynamic loading force fluctuations. The damper includes a case, a ring, a plurality of pockets, a mass, and a fluid. The case at least partially defines a case fluid cavity containing the fluid. The pockets are in the ring and the masses are in the pockets.

### TECHNICAL FIELD

The present disclosure relates to dampers, and more particularly to dampers for engine crankshafts and other rotating components.

### BACKGROUND

Engine crankshafts and other rotating components may experience fluctuations in loading or motion. These fluctuations may come from a variety of sources. Some fluctuations may occur from natural resonance forces of the rotation and other fluctuations may occur from direct loading or vibrational forces.

Dampers may be added to the crankshaft to absorb the fluctuations and smooth the engine's operation and thereby reduce stress on the crankshaft. However, different damper designs may be suited for different sources of fluctuations.

U.S. Pat. No. 6,026,776 (the '776 patent) shows a damper incorporated into a counter balance of the crankshaft. The damper of the '776 patent incorporates inertial masses inside bores in the counter balance. The inertial masses of the '776 patent float in a damping medium contained in the bore.

### SUMMARY

In one aspect, the present disclosure provides a damper including a case, a ring, a plurality of pockets, a plurality of masses, and a fluid. The case at least partially defines a case fluid cavity containing the fluid. The pockets are in the ring and the masses are in the pockets. In another aspect, the present disclosure provides a crank assembly and the damper.

In still another aspect, the present disclosure provides a method of damping fluctuations in motion of a rotating body. The method includes shearing a fluid to dampen rotational force fluctuations. The method also includes moving a plurality of masses within a fluid to dampen dynamic loading force fluctuations.

Other features and aspects of this disclosure will be apparent from the following description and the accompanying drawings.

### BRIEF DESCRIPTION OF THE DRAWINGS

FIG. 1 is a side view of an engine including a damper on a crank assembly;

FIG. 2 is a side view of the crank assembly;

FIG. 3 is a perspective view of the damper shown to include a case, a cover, and a hub;

FIG. 4 is a cross-sectional view of the damper in FIG. 3 showing the damper to include a ring, masses, a bearing, and a fluid; and

FIG. 5 is a front view of the damper rotating with the cover removed for illustrative purposes.

FIG. 6 is a front view of an alternative damper rotating with the cover removed for illustrative purposes.

### DETAILED DESCRIPTION

As seen in FIG. 1, an engine 10 includes a top end 12, block 14, oil pan 16, and crank assembly 18. The top end 12 is mounted or coupled to the top of the block 14 and the oil pan 16 is mounted or coupled to the bottom of the block 14. The crank assembly 18 extends across the block 14 from an engine front 20 to an engine rear 22.

The engine 10 may include other features not shown, such as fuel systems, air systems, cooling systems, peripheries, drivetrain components, turbochargers, etc. The engine 10 may be any type of engine (internal combustion, gas, diesel, gaseous fuel, natural gas, propane, etc.), may be of any size, with any number of cylinders, and in any configuration (“V,” in-line, radial, etc.). The engine 10 may be used to power any machine or other device, including on-highway trucks or vehicles, off-highway trucks or machines, earth moving equipment, generators, aerospace applications, locomotive applications, marine applications, pumps, stationary equipment, or other engine powered applications.

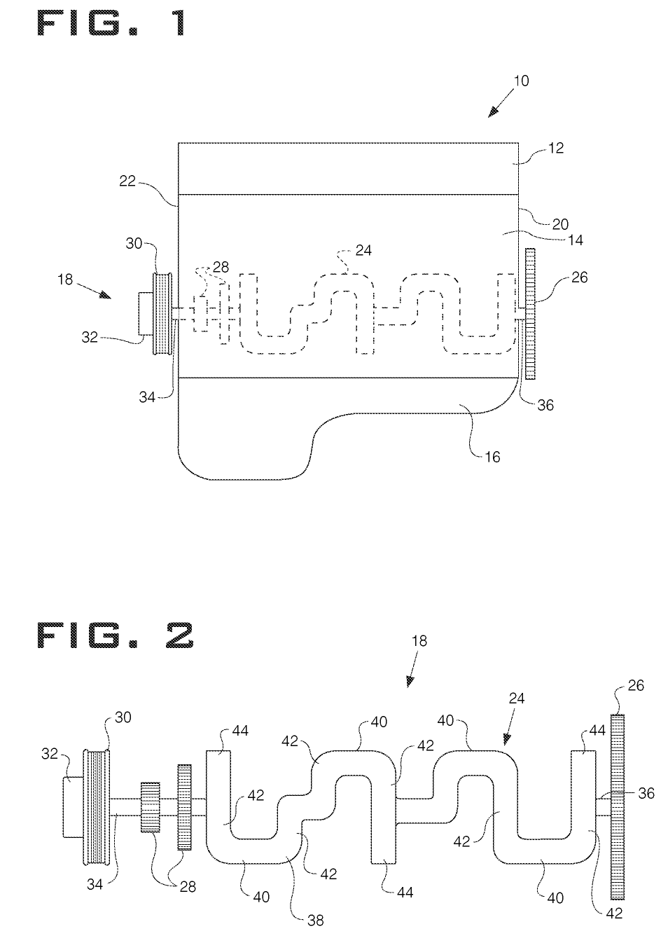

FIG. 2 shows the crank assembly 18 may include a crankshaft 24, a flywheel 26, drive sprockets 28, a pulley 30, and a damper 32. The crankshaft 24 includes a crankshaft rear portion 34, a crankshaft front portion 36, and a crankshaft middle portion 38 extending between. The crankshaft rear portion 34 and crankshaft front portion 36 may extend outside of the block 14.

The crankshaft middle portion 38 may include journals 40 that are coupled with the engine's 10 connecting rods and pistons. Supporting the journals 40 are webs 42. Counter weights 44 may also be included in the crankshaft 24 for balancing and to prevent vibration.

The flywheel 26 may be coupled to the crankshaft front portion 36. The flywheel 26 is used to drive a transmission, generator, or other engine 10 application. The drive sprockets 28 may be included to drive a camshaft, oil pump, or other engine 10 component through a chain or belt. The drive sprockets 28 may be located at either the crankshaft rear portion 34 or the crankshaft front portion 36. The pulley 30 may be coupled to the crankshaft rear portion 34, opposite the flywheel 26. The pulley 30 may be used to drive various engine 10 systems or peripheries, such as power steering pumps, air conditioner pumps, water pumps, alternators, or fans, through a belt. The crank assembly 18 may include one or more pulleys 30.

The damper 32 is shown coupled to the crank assembly 18 outside the block 14 and to the rear of the pulley 30. In other embodiments, the damper 32 may be included in various other locations on the crank assembly 18 outside the block 14. The damper 32 may be on either side of the pulley 30 or other part of the crankshaft rear portion 34. The damper 32 may also be located on the crankshaft front portion 36, on either side of the flywheel 26. In yet other embodiments, the damper 32 may be located within the block 14 on the crankshaft middle portion 38. The damper 32 may be located on either side of or between the drive sprockets 28. The damper 32 may also be located besides or partially within the webs 42 or counter weights 44. The damper 32 may also be oriented with its front or rear facing block 14. Alternative embodiments also contemplate that the damper 32 may be integral with or formed as a part of the pulley 30 or drive sprockets 28.

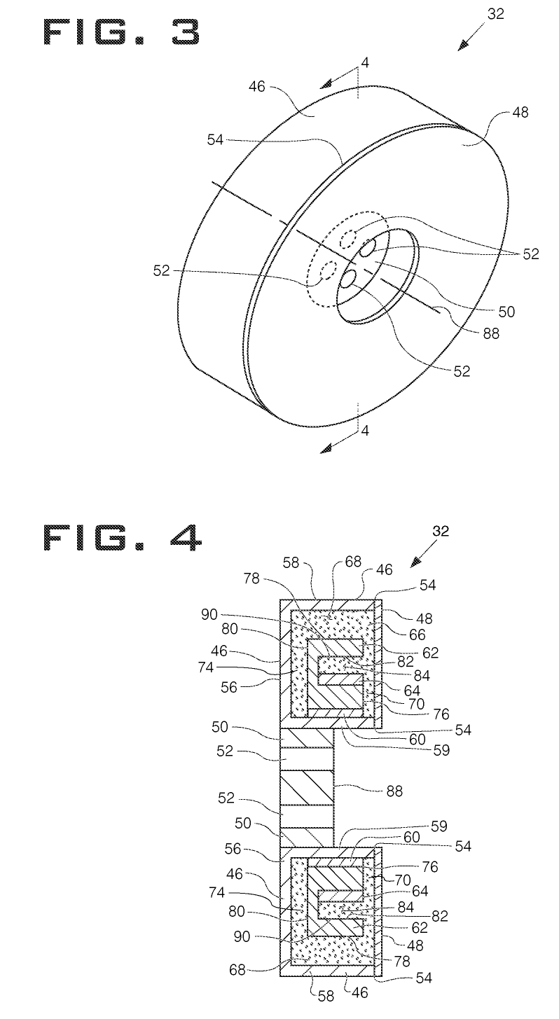

FIG. 3 shows the damper 32 may include a case 46, a cover 48, and a hub 50. The hub 50 may be a disk member including bolt holes 52 through which bolts may be used to couple the damper 32 to the crank assembly 18. The damper 32 may be coupled to the crankshaft 24, pulley 30, flywheel 26, or other crank assembly 18 component. The damper 32 may also be coupled to the crank assembly 18 in a variety of other ways, including welding and other joining techniques.

The case 46 is a disk shaped member coupled to the periphery of the hub 50. The cross-sectional view in FIG. 4 shows the case 46 to have a “C” shaped cross section and include a side portion 56, outer lip portion 58, and inner lip portion 59. The side portion 56 extends from the inner lip portion 59 to the outer lip portion 58. The outer lip portion 58 and inner lip portion 59 extend at an angle from the ends of the side portion 56. The disk shaped cover 48 is coupled to a case end 54 of the outer lip portion 58 and the inner lip portion 59 in a fluid tight manner.

FIG. 4 shows the damper 32 to also include a bearing 60, a ring 62, masses 64, and a fluid 66. The bearing 60 is supported by and surrounds the inner lip portion 59 of the case 46. In alternative embodiments, the bearing 60 may be supported by a portion of the hub 50 and may also surround and be supported by a portion of the crankshaft 24 or a portion of another component the damper 32 may be coupled to.

A case fluid cavity 68 is defined by the case 46 and cover 48. The ring 62 is a disk shaped member located inside the case fluid cavity 68 and surrounding and in contact with the bearing 60. The case fluid cavity 68 may include a front chamber 70, outer chamber 72, and rear chamber 74. The front chamber 70 may be defined by a front ring surface 76 and the cover 48. The outer chamber 72 may be defined by a outer ring surface 78 and the lip portion 58 of the case 46. The rear chamber 74 may be defined by a rear ring surface 80 and the side portion 56 of the case 46.

The ring 62 includes pockets 82 formed in the ring 62 and extending through the front ring surface 76 and defining pocket fluid cavities 84. In alternative embodiments, the pockets 82 may be located in the rear ring surface 80. The pockets 82 may also have a wide variety of depths and sizes. In alternative embodiments, the pockets 82 may also be through going, extending through both the front ring surface 76 and rear ring surface 80.

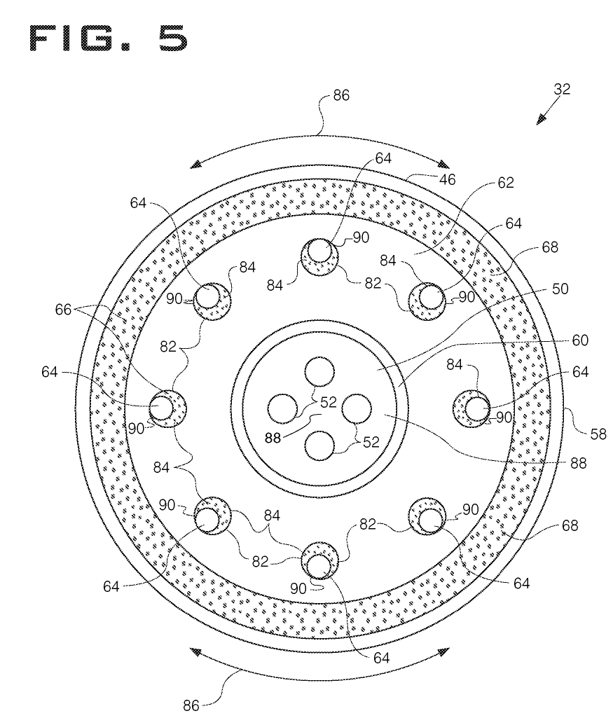

The case fluid cavity 68 may be in fluid communication with the pocket fluid cavity 74. In other embodiments, the pocket fluid cavity 84 may also be fluidly isolated from the case fluid cavity 68. The pockets 82 may be cylindrical with a circular cross-section, as seen in FIG. 5. The pockets 82 may also have other shapes, including oval, square, and rectangular. Also as seen in FIG. 5, the pockets 82 may be located symmetrically around the ring 62.

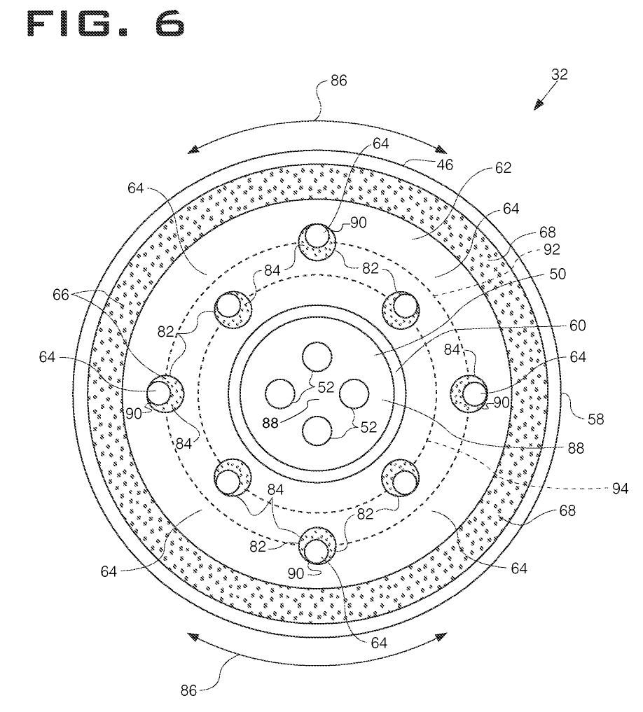

FIG. 6 shows that the pockets may also be located at varying distances from the center 88. One set of pockets 82 is symmetrically distributed along a first perimeter 92 and another set of pockets is symmetrically distributed along a second perimeter 94 located closer to the center 88 than the first perimeter 92. Additional sets of pockets 82 may be located at varying distance from the center 88. Locating sets of pockets 82 at varying distances from the center 88 may provide additional tuning of the damper 32 or tuning at multiple orders. In alternative embodiments, the pockets 82 may also be located in asymmetric patterns and at varying distances from the center 88 given proper balancing.

One mass 64 is located in each pocket fluid cavity 84. The masses 64 may be cylindrical rods, spheres, blocks, or have another geometric shape that fits within the pocket fluid cavity 84. The masses 64 may be longer or shorter than the depth of the pockets 82.

The masses 64 may be loose in the pockets 82 and independent of the ring 62. Accordingly, the masses 64 may move freely within the pocket fluid cavity 84 absent an outside force. In alternative embodiments, the motion of the masses 64 may be limited. For example, the pockets 82 may have an oval cross-section and the masses 64 may be sized so that the masses 64 are free to move only in a radial direction. Additional pockets 82 and pocket fluid cavities 84 may also be included without a mass 64.

The masses 64 may be the same material as or a different material than the ring 62, case 46, or other components. In some embodiments, the masses 64 may be made from a denser material than the ring 62, case 46, or other damper 32 components. The damper 32 components may be made from cast iron, forged steel, stainless steel, or other appropriate material for the intended environment and conditions.

The fluid 66 fills the case fluid cavity 68 and the pocket fluid cavity 84. The fluid 66 may be a silicon based material or any other material that will retain sufficient viscosity in the given environment or conditions. The fluid 66 may be highly viscous with a viscosity of approximately, roughly, or about 100,000 centistokes to approximately, roughly, or about 1,500,000 centistokes.

### INDUSTRIAL APPLICABILITY

FIG. 5 shows the damper 32 with the cover 48 removed for illustrative purposes. The damper 32 is shown spinning in rotation direction 86. The hub 50 and case 46 are spun by the crankshaft 24, imparting a force on the fluid 66. Shearing of the viscous fluid 66 imparts a force on the ring 62, causing the ring 62 and masses 64 to also spin. As the damper 32 spins or rotates, centrifugal forces push the masses 64 away from a center 88 of the spinning damper 32 and to an outside 90 of the pocket fluid cavity 84.

The damper 32 may be suited to accommodate, absorb, or dampen a variety of different sources of energy or motion fluctuations experienced by the crankshaft 24. The damper 32 may use damping methods including a viscous shearing action to dampen the natural resonance forces of the rotation and a pendulum action to dampen the direct loading forces of vibration.

The shearing of the viscous fluid 66 may provide a damping effect of the natural resonance forces of the rotation experienced by the crankshaft 24. As the rotational speed of the crankshaft 24 increases, decreases, accelerates, or decelerates a portion of the mechanical energy generated by the fluctuation or change in speed may be smoothed, absorbed, or dampened. The mechanical energy may be converted to heat as the viscous fluid 66 is sheared in response to the changing speeds of rotation between the case 46 and ring 62.

The moving of the masses 64 may also provide a damping effect of the direct loading forces experienced by the crankshaft 24. Energy is stored in the damper 32 as the centrifugal forces push the masses 64 to the outside 90 of the pocket fluid cavity 84. As a result, the masses 64 may act as pendulums and move within the pocket fluid cavity 84 in reaction to dynamic loading from a vibration, direct loading, or external force. The viscous fluid 66 may resist the movement of the masses 64. As a result, the vibration, direct loading, or external forces may be smoothed, absorbed, or dampened.

While the above description is directed to the damper 32 applied to the crankshaft 24, it is understood that other applications of the damper 32 exist. The damper 32 may be used with engine camshafts, reciprocating pumps, oil pumps, fuel pumps, rotating shafts, rotating axles, driveshafts, or other rotating components. The damper 32 may be particularly suited in applications with rotational speeds that are below 6,000 revolutions per minute (rpm). The size, weight, of the damper's 32 components and the viscosity of the fluid 66 may be designed for a wide range of rotation speeds.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A damper for smoothing motion fluctuations in a rotating body comprising:
a case coupled to the rotating body wherein the case at least partially defines a case fluid cavity inside;
a ring disposed in the case fluid cavity;
a plurality of pockets defining pocket fluid cavities in the ring;
a mass disposed inside the pocket fluid cavities; and
a fluid contained in the case fluid cavity and pocket fluid cavities.

2. The damper of claim 1 wherein:
the fluid in the case fluid cavity is the same as the fluid in the pocket fluid cavities; and
the case fluid cavity and pocket fluid cavities are in fluid communication.

3. The damper of claim 1 further including:
a hub coupled to the rotating body and coupled to the case.

4. The damper of claim 3 further including:
a bearing located in the case wherein the ring surrounds the bearing.

5. The damper of claim 4 further including:
a cover coupled to the case wherein the cover further defines the case fluid cavity.

6. The damper of claim 1 wherein the fluid is a silicon based material with a viscosity of about 100,000 centistokes to about 1,500,000 centistokes.

7. The damper of claim 1 coupled to an engine crankshaft outside an engine block.

8. A crank assembly comprising:
a crankshaft; and
a damper coupled to the crankshaft, the damper including:
a case at least partially defining a case fluid cavity inside;
a ring disposed in the case fluid cavity;
a plurality of pockets in the ring defining pocket fluid cavities;
a mass disposed inside the pocket fluid cavities; and
a fluid contained in the case fluid cavity and pocket fluid cavities.

9. The crank assembly of claim 8 wherein the damper is located outside an engine block.

10. The crank assembly of claim 8 wherein the damper is located on a rear portion of the crankshaft opposite a flywheel.

11. The crank assembly of claim 8 wherein the damper is integral with a pulley coupled to the crankshaft.

12. The crank assembly of claim 8 wherein:
the fluid in the case fluid cavity is the same as the fluid in the pocket fluid cavities; and
the case fluid cavity and pocket fluid cavities are in fluid communication.

13. The crank assembly of claim 8 wherein the fluid is a silicon based material with a viscosity of about 100,000 centistokes to about 1,500,000 centistokes.

14. The crank assembly of claim 8 wherein the damper further includes:
a hub coupled to the rotating body and coupled to the case;
a bearing located in the case wherein the ring surrounds the bearing; and
a cover coupled to the case wherein the cover further defines the case fluid cavity.

15. A method of damping motion fluctuations of a rotating body comprising:
shearing a fluid to dampen rotational force fluctuations; and
moving a plurality of masses within a fluid to dampen dynamic loading force fluctuations.

16. The method of claim 15 wherein the shearing of the fluid is achieved by the rotation of a ring inside a case containing the fluid.

17. The method of claim 16 wherein the masses are contained inside pockets in the ring.

18. The method of claim 15 wherein the masses store energy and act as a pendulum in response to the dynamic loading force fluctuations.

19. The method of claim 15 further including:
a hub coupled to the rotating body and the case;
a bearing coupled to the case; and
a cover coupled to the case wherein the fluid is contained in a cavity defined by the case and cover.

20. The method of claim 15 wherein the rotating body is a camshaft.
